(19) United States
(12) Patent Application Publication
(10) Pub. No.: US 2025/0319456 A1
(43) Pub. Date: Oct. 16, 2025

(54) SHAPED CATALYST BODY FOR MANUFACTURING SYNTHETIC GAS, APPARATUS FOR MANUFACTURING SYNTHETIC GAS INCLUDING THE SHAPED CATALYST BODY, AND METHOD FOR MANUFACTURING SYNTHETIC GAS USING THE SHAPED CATALYST BODY

(71) Applicants: HYUNDAI MOTOR COMPANY, Seoul (KR); Kia Corporation, Seoul (KR)

(72) Inventors: Haeun JEONG, Hwaseong-si (KR); Ji-Hoon JANG, Hwaseong-si (KR); Pyung Soon KIM, Hwaseong-si (KR); Kyung Soo PARK, Hwaseong-si (KR); Byungseok KIM, Gunpo-si (KR); Eunseok KIM, Ansan-si (KR)

(21) Appl. No.: 18/884,970

(22) Filed: Sep. 13, 2024

(30) Foreign Application Priority Data
Apr. 12, 2024 (KR) 10-2024-0049290

(51) Int. Cl. B01J 23/755; B01J 21/04; B01J 35/32; B01J 35/37; B01J 35/51; B01J 35/55; B01J 35/61; B01J 35/64; B01J 37/02; C01B 3/32

(52) U.S. Cl. CPC B01J 23/755; B01J 21/04; B01J 35/32; B01J 35/37; B01J 35/51; B01J 35/55; B01J 35/612; B01J 35/613; B01J 35/643; B01J 35/647; B01J 37/023; C01B 3/326; C01B 2203/0277; C01B 2203/1058; C01B 2203/1082; C01B 2203/1235

(57) ABSTRACT

A shaped catalyst body for manufacturing a synthetic gas according to an aspect includes a catalyst including a carrier and a metal active particle supported on the carrier, wherein a metal oxide coating layer is present on at least a portion of surfaces of the metal active particle and carrier.

### CROSS-REFERENCE TO RELATED APPLICATION

This application claims priority to Korean Patent Application No. 10-2024-0049290, filed on Apr. 12, 2024, the disclosure of which is incorporated herein by reference in its entirety.

### TECHNICAL FIELD

The present disclosure relates to a shaped catalyst body configured to produce a synthetic gas, an apparatus for manufacturing a synthetic gas including the shaped catalyst body, and a method for manufacturing a synthetic gas using the shaped catalyst body.

### BACKGROUND

Gases including hydrogen and carbon monoxide are very important substances in the automotive industry for supplying hydrogen used in fuel cells, in the steel industry for use in iron ore reduction, in the chemical industry for ammonia, methanol, and Fischer-Tropsch synthesis and manufacturing other chemicals, and the like.

In order to produce such gas, synthetic gas is produced from hydrocarbons through a reforming process, mainly using catalysts made of nickel-based alumina or ruthenium-based alumina.

In a reforming process of the related art, a pellet-type catalyst is generally charged into a reactor. A pellet is often manufactured by extrusion molding, and in this case, boehmite is sometimes used to ensure moldability so that it can be extruded into a desired shape. A pellet without a hole inside is not easily damaged, so it is allowed to set a firing temperature high. However, as a diameter of the reactor increases, a pellet with a hole inside, which is advantageous for lowering a reactor pressure, is used. In this case, a catalyst with weak crushing strength may have the following problems.

First, pieces may be generated due to damage due to mechanical shock when loading the catalyst into the reactor, damage upon thermal expansion and contraction during temperature rising to a reforming reaction temperature and shutdown after a reaction, damage during coke production, and the like.

The small pieces resulting from these phenomena fill gaps between the catalyst pellets and can also be filled on a bottom of the reactor, which can cause flow resistance to a reformed gas. For these reasons, when manufacturing a pellet, a catalyst that satisfies both formability and strength needs to be used.

### SUMMARY

An aspect of the present disclosure attempts to provide a shaped catalyst body configured to produce a synthetic gas, which can secure formability and increase crushing strength at the same time.

A shaped catalyst body for manufacturing a synthetic gas according to an aspect includes a catalyst including a carrier and a metal active particle supported on the carrier, wherein a metal oxide coating layer is present on at least a portion of surfaces of the metal active particle and carrier.

The carrier can include alumina and boehmite.

The metal active particle can include one or more species of nickel (Ni), cobalt (Co), rhodium (Rh), ruthenium (Ru), iridium (Ir), palladium (Pd), platinum (Pt), gold (Au), and iron (Fe).

The metal oxide coating layer can include one or more species of alumina (Al₂O₃), silica (SiO₂), magnesia (MgO), magnesium aluminate (MgAl₂O₄), calcium aluminate (CaAl₂O₄), zirconia (ZrO₂), ceria (CeO₂), lantana (La₂O₃), and yttria (Y₂O₃).

The metal active particle can be included in an amount of 5 wt % to 40 wt % and the metal oxide coating layer can be included in an amount of 1 wt % to 7 wt % based on a total of 100 wt % of the catalyst including the carrier, the metal active particle, and the metal oxide coating layer.

The shaped catalyst body can further include a binder.

The binder can be included in an amount of 5 wt % to 20 wt % based on 100 wt % of the shaped catalyst body.

The binder can include one or more species of alumina sol and calcium aluminate cement.

A specific surface area of the shaped catalyst body can be 0.1 m²/g to 20 m²/g, and an average pore diameter can be 1 nm to 50 nm.

A bulk density of the shaped catalyst body can be 1 g/mL to 6 g/mL.

The shaped catalyst body can have a sphere, cylinder, dome-shaped cylinder, or petal shape.

The shaped catalyst body can have one or more holes in the shape.

The shaped catalyst body can have a cylinder shape with a diameter of 2 mm to 25 mm and a height of 1 mm to 30 mm.

The shaped catalyst body can have a crushing strength of 300 N to 3000 N.

A method for manufacturing a shaped catalyst body for manufacturing a synthetic gas according to an aspect includes supporting a metal active particle on a carrier; manufacturing catalyst powder by coating a metal oxide on at least a portion of surfaces of the carrier and metal active particle; manufacturing a shaped catalyst body by shaping the catalyst powder; and firing the shaped catalyst body.

In the manufacturing the shaped catalyst body, a compressive strength can be 1 kN to 20 kN.

The firing can be performed at a temperature of 800° C. to 1500° C.

A method for manufacturing a synthetic gas according to an aspect includes injecting a reaction gas and an oxidizing agent so that they come into contact with the shaped catalyst body for manufacturing a synthetic gas, and reforming the reaction gas through an endothermic reaction to manufacture a synthetic gas.

The reaction gas can include one or more species of C1 to C20 alkane, C1 to C20 alkene, C1 to C20 alkyne, ammonia (NH₃), formaldehyde (HCO₂H) and methanol (CH₃OH).

The oxidizing agent can include one or more species of carbon dioxide (CO₂), steam (H₂O) and oxygen (O₂).

According to the exemplary implementations, the shaped catalyst body for manufacturing a synthetic gas can be manufactured into various shapes, and has a structure that facilitates heat and mass transfer, thereby expanding the reaction surface area and preventing pressure drop.

According to the exemplary implementations, the shaped catalyst body for manufacturing a synthetic gas has a high crushing strength, making it possible to prevent flow resistance from occurring due to crushing of the shaped catalyst body.

### BRIEF DESCRIPTION OF THE DRAWINGS

FIG. 1 is a diagram schematically showing an exemplary catalyst in a shaped catalyst body for manufacturing a synthetic gas according to an exemplary implementation.

FIG. 2 is a diagram schematically showing an exemplary shaped catalyst body for manufacturing a synthetic gas according to an exemplary implementation.

FIG. 3 shows nitrogen adsorption analysis results for catalyst powders.

FIG. 4 shows composition and crystal structure analysis results of exemplary shaped catalyst bodies.

FIG. 5 is a photograph of an exemplary shaped catalyst body.

FIG. 6 is a photograph of an exemplary shaped catalyst body.

FIG. 7 is a photograph of an exemplary shaped catalyst body.

FIG. 8 shows a catalyst performance comparison result of shaped catalyst bodies.

FIG. 9 shows a catalyst performance comparison result of shaped catalyst bodies.

### DETAILED DESCRIPTION

The advantages and features of the technique described below, and a method for achieving the same will become apparent with reference to exemplary implementations described in detail below together with the accompanying drawings. However, it should be noted that the forms to be implemented are not limited to the exemplary implementations disclosed below. Unless otherwise defined, all terms (including technical and scientific terms) used in the present specification may be used as the meaning that may be commonly understood by one skilled in the art. In addition, terms defined in commonly used dictionaries should not be interpreted in an idealized or excessive sense unless defined explicitly and specially.

Throughout the specification, unless explicitly described to the contrary, when a part “includes”, “comprises” or “has” a certain constituent element, this does not mean that another constituent element is excluded, but means that another constituent element can be further included.

In addition, unless particularly stated otherwise, a singular form also includes a plural form.

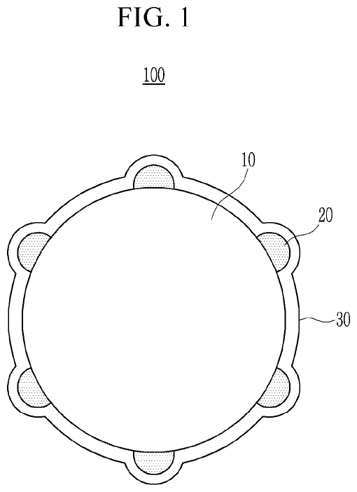

FIG. 1 is a diagram schematically showing a catalyst in a shaped catalyst body 200 for manufacturing a synthetic gas according to an exemplary implementation. As shown in FIG. 1, a catalyst 100 includes a carrier 10 and metal active particles 20 supported on the carrier. A metal oxide coating layer 30 is present on at least a portion of surfaces of the carrier 10 and the metal active particles 20.

First, the configuration of the catalyst 100 will be described in detail.

The carrier includes alumina (Al₂O₃) and boehmite (AlOOH). An aspect of the present disclosure is to manufacture a shaped body by shaping a catalyst, and when shaping catalyst powder, cracks can occur if boehmite is not included. On the other hand, if boehmite is appropriately included, formability can be improved. Boehmite can be included in an amount of 10 to 30 parts by weight based on 100 parts by weight of alumina. If boehmite is not appropriately included, it is difficult to obtain sufficient formability. If boehmite is excessively included, the catalyst production cost may increase. Alumina can be present in an alpha-alumina form.

The carrier 10 can include mesopores with an average pore size of 2 nm to 50 nm. If the pores are too small, the dispersion of the metal active particles 20 may decrease. If the pores are too large, the metal active particles 20 can be easily sintered, lowering the activity. More specifically, the carrier 10 can include mesopores with an average pore size of 5 nm to 30 nm.

The metal active particles 20 are a component having activity in converting a reaction gas to produce a synthetic gas and supported on the carrier 10. The metal active particle can include one or more species of nickel (Ni), cobalt (Co), rhodium (Rh), ruthenium (Ru), iridium (Ir), palladium (Pd), platinum (Pt), gold (Au), and iron (Fe). More specifically, nickel (Ni) may be included.

According to an aspect, the metal active particles 20 can be included in an amount of 5 wt % to 40 wt % based on a total of 100 wt % of the catalyst 100 including the carrier 10, the metal active particles 20, and the metal oxide coating layer 30. If the content of the metal active particles 20 is too small, an amount of active metal itself to convert a reforming raw material is insufficient, which can deteriorate the catalyst performance. If the content of the metal active particles 20 is too large, metal can be easily sintered during a reaction, which may deteriorate the catalyst performance. More specifically, the amount of metal active particles 20 can be 10 wt % to 20 wt % based on the total of 100 wt % of the catalyst 100.

The metal oxide coating layer 30 is present on at least a portion of the surfaces of the metal active particles and the carrier, and can prevent a decrease in activity of the metal active particles 20 due to sintering.

The metal oxide coating layer 30 can include one or more species of alumina (Al₂O₃), silica (SiO₂), magnesia (MgO), magnesium aluminate (MgAl₂O₄), calcium aluminate (CaAl₂O₄), zirconia (ZrO₂), ceria (CeO₂), lantana (La₂O₃), and yttria (Y₂O₃).

According to an aspect, the metal oxide coating layer 30 can be included in an amount of 1 wt % to 7 wt % based on the total of 100 wt % of the catalyst 100 including the carrier 10, the metal active particles 20, and the metal oxide coating layer 30. If the content of the metal oxide coating layer 30 is too small, a coating amount is insufficient, which may cause the metal active particles 20 to be sintered and decrease the activity. If the content of the metal oxide coating layer 30 is too large, mass transfer resistance may increase due to a thickness of the coating layer. More specifically, the metal oxide coating layer 30 can be included in an amount of 1 wt % to 3 wt % based on the total of 100 wt % of the catalyst 100. Portions other than the metal active particles 20 and the metal oxide coating layer 30 in the catalyst 100 can become the carrier. More specifically, the carrier can be included in an amount of 53 wt % to 94 wt %.

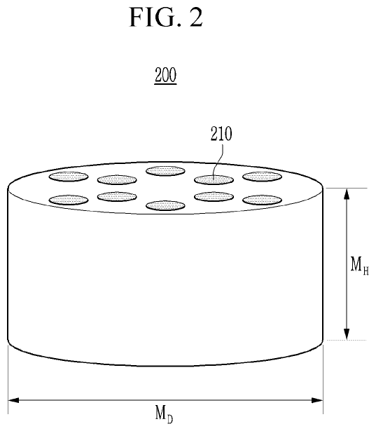

FIG. 2 is a diagram schematically showing a shaped catalyst body 200 for manufacturing a synthetic gas according to an exemplary implementation. By shaping the catalyst 100 powder described above, the shaped catalyst body 200 can be manufactured.

For catalyst shaping, a binder may be further included in addition to the catalyst 100. Specifically, the binder can be included in an amount of 1 wt % to 20 wt % based on 100 wt % of the shaped catalyst body 200. The remainder can become the catalyst 100. If the content of the binder is too small, the catalyst may not be shaped. If the content of the binder is too large, the strength of the shaped catalyst body 200 may be reduced. More specifically, the binder can be included in an amount of 3 wt % to 5 wt % based on 100 wt % of the shaped catalyst body 200.

The binder can include one or more species of alumina sol and calcium aluminate cement.

A specific surface area of the shaped catalyst body 200 can be 0.1 m²/g to 20 m²/g, and an average pore diameter can be 1 nm to 50 nm. If the specific surface area is too small or the average pore diameter is too small, an area in which the reaction gas comes into contact with the metal active particles 20 can decrease, thereby reducing the catalyst activity. If the specific surface area is too large or the average pore diameter is too large, the strength may not be sufficient. More specifically, the specific surface area can be 1.0 m²/g to 15.0 m²/g. The average pore diameter can be 1.0 nm to 10 nm. The specific surface area can be measured by a BET method. The average pore diameter can be measured using a BJH method and a porosity analyzer (Porosimeter).

A bulk density of the shaped catalyst body 200 can be 1 g/mL to 6 g/mL. If the bulk density is too low, the strength of the shaped body can be reduced. If the bulk density is too high, an amount of active metal unused in the reaction can increase. The bulk density can be measured using a porosity analyzer (Porosimeter).

The shape of the shaped catalyst body 200 is not particularly limited, but may be, for example, a sphere, cylinder, dome-shaped cylinder, or petal. Additionally, the shaped catalyst body 200 can have one or more holes inside so as to be advantageous for lowering a pressure of a reactor. The holes are intentionally formed during the shaping process of the shaped catalyst body 200, have a diameter of 1 μm or greater, and are distinguished from pores.

More specifically, the shaped catalyst body 200 can have a cylinder shape with a diameter (M_{D}) of 2 mm to 25 mm and a height (M_{H}) of 1 mm to 30 mm. FIG. 2 illustrates the shaped catalyst body 200 having a cylinder shape with 10 (ten) holes 210. Specifically, the number of holes 210 can be 3 to 10. In addition, the holes can have a cylinder shape with a diameter (M_{D}) of 3 mm to 20 mm and a height (M_{H}) of 3 mm to 20 mm.

The shaped catalyst body 200 according to an aspect has high crushing strength, preventing flow resistance from occurring due to crushing of the shaped catalyst body. Specifically, the shaped catalyst body 200 can have a crushing strength of 300 N to 3000 N. If the crushing strength is too high, the shaping may be inefficient due to excessive energy consumption or a decrease in surface area in which the active metal can be supported. More specifically, the crushing strength can be 500 N to 1500 N. The crushing strength can be measured by compressive strength using a universal testing machine.

A method for manufacturing a shaped catalyst body 200 for manufacturing a synthetic gas according to an aspect includes a step of supporting metal active particles 20 on a carrier 10; a step of manufacturing catalyst 100 powder by coating a metal oxide on at least a portion of surfaces of the carrier 10 and metal active particles 20; a step of manufacturing a shaped catalyst body 200 by shaping the catalyst 100 powder; and a step of firing the shaped catalyst body 200.

First, metal active particles 20 are supported on a carrier 10. Since the carrier 10 and the metal active particles 20 have been described above, redundant descriptions will be omitted. When the carrier 10 includes alumina and boehmite, boehmite can be mixed with alumina by using a dry impregnation method (Incipient Wetness Impregnation). Specifically, boehmite can be mixed in a manner of dispersing boehmite in a solvent, mixing boehmite with alumina, and then drying the mixture. The supporting method can be carried out in a manner of dispersing the metal active particles 20 or a precursor thereof in a solvent, adding and stirring the carrier 10, stirring, and then drying the mixture. The precursor of the metal active particles 20 is a material that becomes the metal active particles 20 by firing, and specifically can be a nitrate of the metal active particles. More specifically, nickel nitrate can be used.

Next, a metal oxide is coated on at least a portion of surfaces of the carrier 10 and the metal active particles 20. The carrier 10, the metal active particles 20, and the metal oxide or precursor thereof can be stirred and then coated using a melt infiltration process. The precursor of the metal oxide is a material that becomes a metal oxide by firing, and specifically can be aluminum isopropoxide.

Next, the catalyst 100 powder is shaped to manufacture the shaped catalyst body 200. First, after mixing a binder with the catalyst powder, the mixture is atomized and put into a rotary continuous tableting machine to shape the mixture into a desired shape of a shaped body. In this case, the compressive strength can be 1 kN to 20 kN. More specifically, a compressive strength of 2 kN to 5 kN can be used. A rotation speed of a rotor can be 5 RPM to 30 RPM.

Next, the shaped catalyst body 200 is fired. At this time, the shaped catalyst body can be fired at a temperature of 800° C. to 1500° C. If the firing temperature is too low, the strength of the shaped catalyst body 200 may be lowered. If the firing temperature is too high, problems with catalyst activity may occur. More specifically, the shaped catalyst body can be fired at a temperature of 1000°° C. to 1300° C.

A method for manufacturing a synthetic gas according to an exemplary implementation includes injecting a reaction gas and an oxidizing agent so that they come into contact with the shaped catalyst body for manufacturing a synthetic gas described above, and reforming the reaction gas through an endothermic reaction to manufacture a synthetic gas.

As an example, the method for manufacturing a synthetic gas is a method of converting methane and steam, which are raw materials for existing steam reforming, into a synthetic gas by adding carbon dioxide, which is a major greenhouse gas, to methane and steam, and for example, may perform combined steam and carbon dioxide reforming of methane expressed in Reaction Scheme 1 below to manufacture a synthetic gas including carbon monoxide and hydrogen.

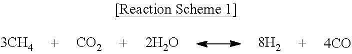

The reaction gas can include one or more species of C1 to C20 alkane, C1 to C20 alkene, C1 to C20 alkyne, ammonia (NH₃), formaldehyde (HCO₂H) and methanol (CH₃OH).

The oxidizing agent can include carbon dioxide (CO₂), steam (H₂O), oxygen (O₂), or a combination thereof.

As an example, the reaction gas can include methane, and carbon dioxide and water as the oxidizing agent, and in this case, the synthetic gas can include hydrogen and carbon monoxide. As an example, water can be included in the reaction gas in the form of steam.

The synthetic gas manufacturing method is to supply the reaction gas by adjusting the molar ratio in order to obtain the synthetic gas of the required composition.

The reaction gas can include methane and the oxidizing agent (carbon dioxide and water) at a molar ratio of 1:1 to 1:3, for example, 1:1.2 to 1:2.

If the molar ratio of the oxidizing agent is less than 1, the conversion rate of methane will decrease and the amount of carbon deposition will increase, which may cause deactivation of the catalyst. If the molar ratio exceeds 3, the conversion rate of carbon dioxide will decrease and the surface of the catalytically active material will be oxidized, which may reduce an amount of hydrogen generated. The molar ratio of methane and oxidizing agent of 1:1.2 to 1:2 may be an optimal ratio, considering the conversion rate of the reaction gas, a ratio of H₂/CO in the product gas, and the amount of carbon deposition.

Note that in the case of combined reforming, the reaction gas can further include nitrogen along with methane, carbon dioxide, and water. Nitrogen can be included at a molar ratio of 1:1 to 1:3 with respect to methane. Nitrogen can be used as a diluent to reduce the temperature variation of the catalyst layer during the reaction.

The reaction gas can be supplied at a space velocity of 500/h to 20000/h, for example 1000/h to 10000/h. The supply rate of the reaction gas can be increased proportionally depending on the size of the combined reforming reactor and the capacity of the catalyst.

The reaction temperature and pressure of combined reforming can be appropriately adjusted depending on the composition of the required synthetic gas. For example, the temperature condition for the combined reforming reaction can be 600° C. to 1000° C., for example, 650° C. to 900° C., or 800° C. to 950° C. If the reaction temperature is lower than 600° C., the conversion rate of carbon dioxide is significantly lowered and CO2 may be rather generated, and if the reaction temperature exceeds 1000° C., the heat energy is consumed inefficiently, which may cause thermal deactivation of the catalyst.

Additionally, the pressure condition for the combined reforming reaction can be, for example, 0.5 atm to 20 atm, for example, 1 atm to 10 atm. If the reaction pressure exceeds 20 atm, the conversion rate of reaction gases may decrease, and the ratio of H₂/CO may vary.

According to the method for manufacturing a synthetic gas using a catalyst, the conversion rate of methane and/or carbon dioxide relative to the reaction gas can be 30 mol % to 99.9 mol %, and may be stable against carbon deposition at 900° C. for up to 100 hours.

Below, specific examples of the invention are presented. However, the examples described below are only for illustrating or describing the invention in detail and should not be construed as limiting the scope of the present disclosure.

### Preparation Example: Preparation of Shaped Catalyst Body

### 1) Preparation of Carrier

8 g of commercial alumina (Al₂O₃, Sasol, HP14-150) and 2 g of boehmite (AlOOH) were mixed with each other in a solid state. Deionized water was added in an amount of 10 wt % with respect to the boehmite solid content, which was then stirred for 1 hour. After the stirring, the mixture was dried at 100° C. for 4 hours in an air atmosphere. In Comparative Example 3, a carrier was prepared using only commercial alumina.

### 2) Active Metal Particles

10 g of the carrier prepared in the above step and 2 g of nickel nitrate were mixed with each other in a solid state. Deionized water was added to support nickel nitrate. After stirring was completed, a drying process was performed at a temperature of 100° C. for 10 hours in an air atmosphere.

### 3) Metal Oxide Coating

0.18 g of aluminum isopropoxide was added to 10 g of powder prepared in the above step, which was then stirred for 30 minutes in a solid state. Then, a metal oxide coating was prepared using a melt infiltration process.

### 4) Shaping Into Shaped Catalyst Body

For tableting of the catalyst, a binder was added in an amount of 5 wt % with respect to the solid content. After adding the additive, the mixture was dried at 100° C. for 6 hours. After drying, the catalyst powder was atomized using a high shear mill. Before putting the powder into the tableting equipment, deionized water was added to adjust the moisture content to 10 wt %, and then the mixture was put into a rotary continuous tableting machine through a hopper and shaped into a cylinder shape. The catalyst powder was put into the tableting machine and prepared into a shaped catalyst body by using a tableting pressure of 3 kN and setting the rotation speed of the rotor to 20 RPM.

### 5) Firing

The shaped catalyst body prepared in the above step was exposed to a high temperature of 900° C. for 1 hour (temperature increase rate: 5° C./min.) in an air atmosphere, and also exposed at the firing temperature of each of Examples and Comparative Examples as shown in Table 1for 2 hours (temperature increase rate: 2° C./min.), so that a shaped catalyst body was finally prepared.

TABLE 1

| | | | Boehmite | Al₂O₃ | | Firing |
|---|---|---|---|---|---|---|
| | | | mixed or | coating | Kind of | temperature |
| | Catalyst name | Shape | not | or not | binder | (° C.) |
| Example 1 | Ni/[B—Al₂O₃]@Al₂O₃ | 10 hole cylinder | ◯ | ◯ | Al₂O₃ sol | 1200 |
| | | 15 × 11 mm | | | | |
| Example 2 | Ni/[B—Al₂O₃]@Al₂O₃ | 10 hole cylinder | ◯ | ◯ | Al₂O₃ sol | 1150 |
| | | 15 × 11 mm | | | | |
| Example 3 | Ni/[B—Al₂O₃]@Al₂O₃ | 10 hole cylinder | ◯ | ◯ | Calcium | 1500 |
| | | 15 × 11 mm | | | Aluminate | |
| | | | | | Cement | |
| Comparative | Commercial Ni | 10 hole cylinder | — | X | — | — |
| Example 1 | catalyst | 15 × 11 mm | | | | |
| Comparative | Commercial Ni | 10 hole cylinder | — | X | — | — |
| Example 2 | catalyst | 15 × 11 mm | | | | |
| Comparative | Ni/[Al₂O₃]@Al₂O₃ | 10 hole cylinder | X | ◯ | Al₂O₃ sol | 900 |
| Example 3 | | 15 × 11 mm | | | | |
| Comparative | Ni/[B—Al₂O₃]@Al₂O₃ | 10 hole cylinder | ◯ | ◯ | Al₂O₃ sol | 900 |
| Example 4 | | 15 × 11 mm | | | | |
| Example 4 | Ni/[B—Al₂O₃]@Al₂O₃ | Cylinder 4.5 × 4.5 mm | ◯ | ◯ | Al₂O₃ sol | 1200 |
| Comparative | Commercial Ru | Cylinder 4.5 × 4.5 mm | — | X | — | — |
| Example 5 | catalyst | | | | | |
| Comparative | Ni/[Al₂O₃]@Al₂O₃ | Cylinder 4.5 × 4.5 mm | X | ◯ | Al₂O₃ sol | 900 |
| Example 6 | | | | | | |
| Comparative | Ni/[B—Al₂O₃] | Cylinder 4.5 × 4.5 mm | ◯ | X | Al₂O₃ sol | 1200 |
| Example 7 | | | | | | |

### Experimental Example 1: Nitrogen Adsorption Analysis of Catalyst Powder

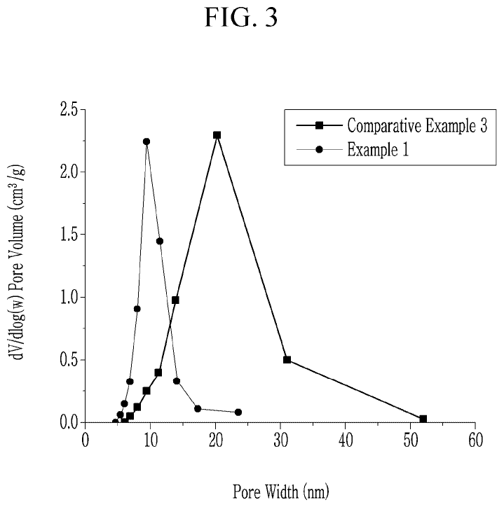

Example 1 and Comparative Example 3 were analyzed using the BJH method from the nitrogen adsorption isotherm in the catalyst powder state before shaping, and the results are shown in FIG. 3.

In Comparative Example 3 where the carrier was prepared without using boehmite, the average pore size was 20 nm and the pore size distribution was wide. If nickel is supported on such a carrier, it can be easily sintered during the reaction, which may cause a decrease in activity and the formation of coke. On the other hand, in Example 1 where the carrier was prepared by adding boehmite, the average pore size was 10 nm, it can be confirmed that the pore distribution was more uniform than that in Comparative Example 3. It can be confirmed that when nickel is supported on such a carrier, sintering during the reaction is reduced due to the pore partition walls, thereby improving the durability of the catalyst.

### Experimental Example 2: Catalyst Composition and Crystal Structure Analysis

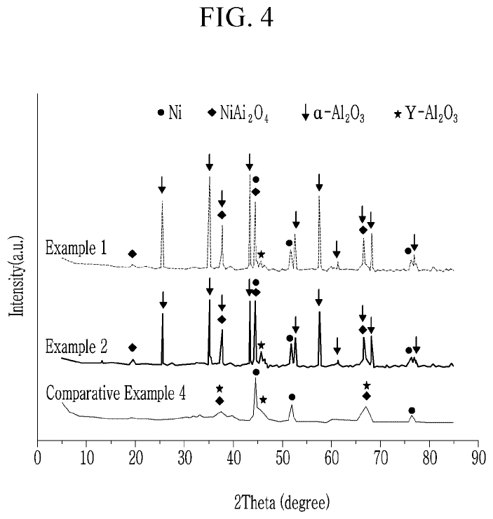

X-ray diffraction (XRD) analysis was performed so as to analyze the composition and crystal structure of the catalyst, and the results are shown in FIG. 4.

It can be confirmed that in Comparative Example 4, alumina is the γ phase, and in Examples 1 and 2, alumina changes to the α phase as the firing temperature increases.

### Experimental Example 3: Catalyst Pore Analysis

In order to analyze the pore structure of the catalyst powder before shaping, the BET specific surface area and the BJH average pore size were analyzed. In order to remove moisture and surface-adsorbed substances, the catalyst powder was subjected to a continuous heat treatment process under conditions of 90° C. for 1 h and 350° C. for 4 h in a vacuum state. Then, nitrogen was adsorbed and desorbed at a temperature of −196° C., and the amounts thereof were measured to determine the specific surface area and pore size of the catalyst powder. The results are summarized in Table 2 below.

TABLE 2

| | | | Comparative |
|---|---|---|---|
| | Example 1 | Example 2 | Example 4 |
| BET specific surface area (m²/g) | 5.15 | 9.33 | 87.04 |
| Pore area (m²/g) | 14.72 | 8.26 | 91.09 |
| Pore size (nm) | 3.41 | 3.06 | 30.7 |

In Table 2, the BET specific surface areas of Examples 1 and 2 and Comparative Example 4 can be confirmed. In the case of a-alumina, a decrease in specific surface area can be confirmed. This can also be confirmed in the pore area of the shaped catalyst using the mercury intrusion technique. As a result of pore size analysis using the BJH method, it can be confirmed that the Examples of the present invention have mesopores.

Through this, it can be confirmed that in the case of the shaped catalyst, the formation of α-alumina was the cause of the strength improvement.

### Experimental Example 4: Strength Measurement of Shaped Catalyst Body

For strength analysis, crushing strength was measured using a compression testing machine. The crushing strength was measured using a universal testing machine Unitech-M, and the results are shown in Table 3.

TABLE 3

| | | | Comparative |
|---|---|---|---|
| | Example 1 | Example 3 | Example 3 |
| Strength (N) | 853 | 511 | 141 |

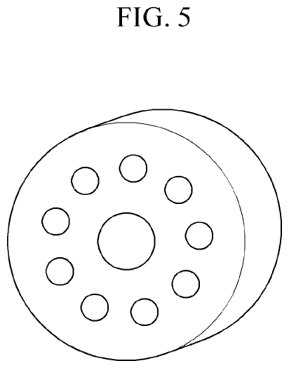

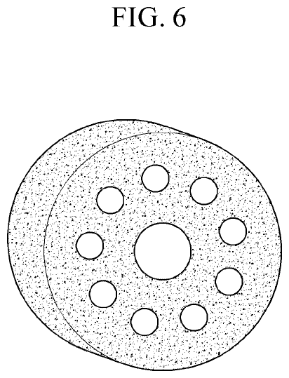

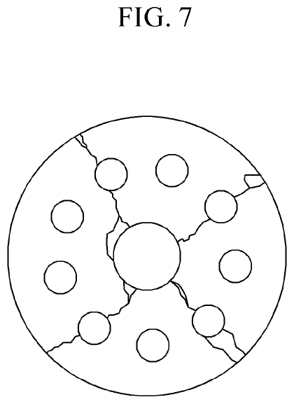

Additionally, photographs of the shaped catalyst bodies of Example 1, Example 3, and Comparative Example 3 are shown in FIGS. 5 to 7, respectively.

In Comparative Example 3 where boehmite was not added to the carrier, it can be confirmed that cracks occurred during shaping. On the other hand, in Example 1 where boehmite was added, it can be confirmed that the formability was improved.

In addition, it can be confirmed that the catalyst of Comparative Example 3 has a very low crushing strength. In Example 1, the crushing strength was very excellent after heat treatment at 1200° C., and in Example 3, heat treatment was performed at 1500° C., but it was confirmed that the strength did not increase significantly compared to Example 1.

### Experimental Example 5: Synthetic Gas Production 1

The combined reforming was performed using methane as the reaction gas and carbon dioxide and steam as the oxidizing agent. The shaped catalyst body was fixed in the 4 in. reactor, the temperature was raised to 1000° C. in a hydrogen atmosphere and reduction was performed for 3 hours. Then, CH₄, CO₂, and H₂O were injected at a ratio of CH₄:CO₂:H₂O=1:0.5:1 while changing the space velocity (SV) from 500/h to 4000/h. The temperature was 1000° C. and the pressure was 1 bar.

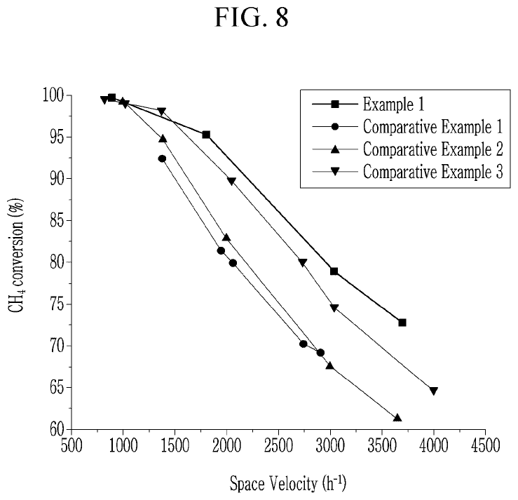

FIG. 8 shows the performance evaluation results of Example 1 and Comparative Examples 1 to 3. It can be confirmed that Example 1 proposed by the present invention maintains the highest performance even under harsh conditions compared to the commercial catalysts of Comparative Examples 1 and 2, and Comparative Example 3 where the firing temperature was lower.

### Experimental Example 6: Synthetic Gas Production 2

The combined reforming was performed using methane as the reaction gas and carbon dioxide and steam as the oxidizing agent. The shaped catalyst body was fixed in the 1 in. reactor, the temperature was raised to 900° C. in a hydrogen atmosphere and reduction was performed for 1 hours. Then, CH₄, CO₂, and H₂O were injected at a ratio of CH₄:CO₂:H₂O=1:0.5:1 at a space velocity (SV) of 9000/h. The temperature was 900° C. and the pressure was 1 bar.

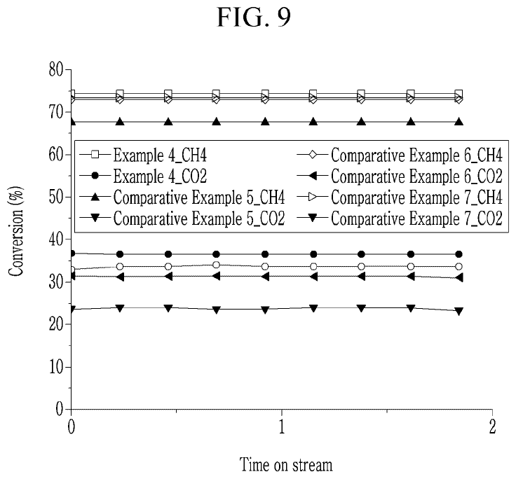

FIG. 9 shows the performance evaluation results. In Example 4, the performance was the highest, and in Comparative Example 5 where the Ru-based commercial catalyst was used, the performance was the lowest. In Comparative Example 6 where the firing temperature was 900° C., particularly low performance can be seen in terms of CO₂ conversion rate. Finally, in Comparative Example 7 where Al₂O₃ coating was not made during the catalyst preparation, the performance deterioration can be seen in terms of CH₄ and CO₂ conversion rates. It is expected 10 that as the reaction time increases, Ni is sintered and performance deterioration further increases.

<Description of symbols>

| | |
|---|---|
| 100: catalyst, | 10: carrier, |
| 20: active metal particle, | 30: metal oxide coating layer. |
| 200: shaped catalyst body, | 210: hole |

What is claimed is:

1. A shaped catalyst body configured to produce a synthetic gas, comprising:
a catalyst comprising a carrier and a metal active particle disposed on the carrier,
wherein a metal oxide coating layer is disposed at at least a portion of a surface of the metal active particle and carrier.

2. The shaped catalyst body of claim 1, wherein:
the carrier comprises alumina and boehmite.

3. The shaped catalyst body of claim 1, wherein:
the metal active particle comprises one or more of nickel (Ni), cobalt (Co), rhodium (Rh), ruthenium (Ru), iridium (Ir), palladium (Pd), platinum (Pt), gold (Au), and iron (Fe).

4. The shaped catalyst body of claim 1, wherein:
the metal oxide coating layer comprises one or more of alumina (Al₂O₃), silica (SiO₂), magnesia (MgO), magnesium aluminate (MgAl₂O₄), calcium aluminate (CaAl₂O₄), zirconia (ZrO₂), ceria (CeO₂), lantana (La₂O₃), and yttria (Y₂O₃).

5. The shaped catalyst body of claim 1, wherein:
the metal active particle is included in an amount of 5 wt % to 40 wt % and the metal oxide coating layer is included in an amount of 1 wt % to 7 wt % based on a total of 100 wt % of the catalyst comprising the carrier, the metal active particle, and the metal oxide coating layer.

6. The shaped catalyst body of claim 1, wherein:
the shaped catalyst body further comprises a binder.

7. The shaped catalyst body of claim 6, wherein:
the binder is included in an amount of 1 wt % to 20 wt % based on 100 wt % of the shaped catalyst body.

8. The shaped catalyst body of claim 6, wherein:
the binder comprises one or more of alumina sol and calcium aluminate cement.

9. The shaped catalyst body of claim 1, wherein:
a surface area of the shaped catalyst body is 0.1 m²/g to 20 m²/g, and an average pore diameter is 1 nm to 50 nm.

10. The shaped catalyst body of claim 1, wherein:
a bulk density of the shaped catalyst body is 1 g/mL to 6 g/mL.

11. The shaped catalyst body of claim 1, wherein:
the shaped catalyst body has a sphere, cylinder, dome-shaped cylinder, or petal shape.

12. The shaped catalyst body of claim 11, wherein:
the shaped catalyst body includes a plurality of holes that are defined in the shaped catalyst body.

13. The shaped catalyst body of claim 11, wherein:
the shaped catalyst body has a cylinder shape with a diameter of 2 mm to 25 mm and a height of 1 mm to 30 mm.

14. The shaped catalyst body of claim 11, wherein:
the shaped catalyst body has a crushing strength of 300 N to 3000 N.

15. A method for manufacturing a shaped catalyst body configured to produce a synthetic gas, the method comprising:
disposing a metal active particle on a carrier;
producing a catalyst powder by disposing a metal oxide on at least a portion of a surface of the carrier and metal active particle;
shaping the catalyst powder to form the shaped catalyst body; and
exposing the shaped catalyst body to heat.

16. The method of claim 15, wherein:
the shaping of the shaped catalyst body comprises using a compressive strength that is 1 kN to 20 kN.

17. The method of claim 15, wherein:
the shaped catalyst body is exposed to a temperature of 800° C. to 1500° C.

18. A method for producing a synthetic gas comprising:
contacting a reaction gas and an oxidizing agent with the shaped catalyst body of claim 1; and
reforming the reaction gas through an endothermic reaction, thereby producing a synthetic gas.

19. The method of claim 18, wherein:
the reaction gas comprises one or more of C1 to C20 alkane, C1 to C20 alkene, C1 to C20 alkyne, ammonia (NH₃), formaldehyde (HCO₂H), and methanol (CH₃OH).

20. The method of claim 18, wherein:
the oxidizing agent comprises one or more of carbon dioxide (CO₂), steam (H₂O), and oxygen (O₂).
